(19) United States
(12) Patent Application Publication
(10) Pub. No.: US 2011/0109518 A1
(43) Pub. Date: May 12, 2011

(54) CAR REAR GLASS ANTENNA

(75) Inventors: Jong Hyun Kang, Yongin (KR); Ho-Sung Choo, Seoul (KR); Woo-Jun Kang, Seoul (KR)

(73) Assignees: HYUNDAI MOTOR COMPANY, Seoul (KR); HONGIK INDUSTRY-ACADEMIC COOPERATION FOUNDATION, Seoul (KR)

(21) Appl. No.: 12/839,525

(22) Filed: Jul. 20, 2010

(30) Foreign Application Priority Data
Nov. 11, 2009 (KR) 10-2009-0108373

(51) Int. Cl. H01Q 1/32

(52) U.S. Cl. 343/713

(57) ABSTRACT

The present invention features a car rear glass antenna which is preferably used for improving a vertical polarization radiation gain for the performance improvement of the vertical polarization radiation gain of the rear glass antenna and extending an antenna bandwidth. The car rear glass antenna preferably includes a plurality of horizontal lines and lattice lines formed in a vertical direction to the horizontal lines, wherein a conductive strip line is printed on a portion of the lattices to make current flow through the portion of the lattices.

### CROSS-REFERENCE TO RELATED APPLICATION

This application is based on and claims under 35 U.S.C. §119(a) priority the benefit of Korean Patent Application No. 10-2009-0108373, filed on Nov. 11, 2009, in the Korean Intellectual Property Office, the disclosure of which is incorporated herein in its entirety by reference.

### BACKGROUND OF THE INVENTION

1. Field of the Invention

The present invention relates, generally, to communication technology that is applied to a car, and more particularly, to a car rear glass antenna.

2. Description of the Related Art

An FM radio set is the oldest technology among wireless communication technologies that has been applied to cars, and its antenna performance is determined by a pole-shaped antenna that is generally mounted on the outside of a car. Recently, a built-in type on-glass antenna that is printed on a rear surface or a side surface of a car has been widely introduced. The glass antenna is printed on a glass substrate having a high dielectric constant, and in the case of a rear glass, a conductive strip line is also used as a heat line, and thus it has a narrow bandwidth and low vertical polarization radiation gain.

Generally, a car rear glass antenna is formed by inserting a very fine conductor line having a width of equal to or smaller than 0.3 mm into an intermediate layer of laminated glasses of a rear glass or printing a conductor line on the rear glass. Since the glass, in the same manner as the air, is considered as an insulator in high-frequency, it serves to make a conductive line levitate in the air.

If the impedance of a receiving end portion of the antenna does not coincide with the inherent impedance of a feeder that is a conductive line for transferring a high-frequency voltage induced from the antenna to a tuner, the voltage distribution of the feeder is not constant to cause the voltage level of the feeder to become uneven (voltage standing wave), and thus it may be impossible to send the received high-frequency power to the tuner with good efficiency.

Since the rear glass, which is considered as an insulator, is surrounded by a car body that forms a conductor, it does not have sufficient area required as the insulator, and since the shapes of the car body and the glass exert an influence upon the matching of the impedance of the antenna receiving end portion and the inherent impedance of the feeder, it is difficult to know the length or shape of the conductor line for designing an optimum antenna.

Recently, two vertical lines having the same length are inserted among 12 to 15 horizontal heat lines, and the impedance matching with an additional circuit is made using a tuning line at an upper end or lower end of the glass. Since such a car rear glass antenna reduces the length of the conductor line formed on the rear glass, the shape of the antenna and the heat lines formed on the rear glass can be simplified while the receiving sensitivity and the directionality of the antenna are maintained.

Accordingly, there is a need in the art for new and improved car rear glass antennas.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a car rear glass antenna that uses a lattice structure for suitably improving a vertical polarization radiation gain for the performance improvement of the vertical polarization radiation gain of the rear glass antennal and extending an antenna bandwidth.

In preferred embodiments, the present invention provides a car rear glass antenna which preferably includes a plurality of horizontal lines and lattice lines formed in a vertical direction to the horizontal lines, wherein a conductive strip line is suitably printed on a portion of the lattices to make current flow through the portion of the lattices.

According to a preferred embodiment, the plurality of horizontal lines is 12 to 18 horizontal lines, and 5 to 6 of the horizontal lines from an upper end thereof correspond to an AM antenna, while the others thereof correspond to an FM antenna.

According to another preferred embodiment, the conductive strip line is printed only on the lattices that correspond ⅔ of the plurality of horizontal lines from a lower end thereof only for the FM antenna.

According to still another preferred embodiment, the conductive strip line is printed on the lattices that correspond to all of the horizontal lines for the FM antenna and the AM antenna.

According to a preferred embodiment, the position of the lattices is suitably changed in accordance with the position of the conductive strip line to be suitable to an FM diversity antenna or a TDMB antenna.

According to another further preferred embodiment, a gap between the lattice lines is more than twice a gap between the horizontal lines.

According to another preferred embodiment, the number of the lattice lines is substantially the same as the number of the horizontal lines.

According to a preferred embodiment, the lattice lines is in the form of a trapezoid of which a lower portion is wider than an upper portion thereof, and the lattice lines are symmetrically positioned from their center.

According to another preferred embodiment, the car rear glass antenna further includes antenna feeding parts provided on both side surfaces of the trapezoid.

According to another further preferred embodiment, the position of the lattice lines is suitably determined by an impedance value that is changed in accordance with left and right side surfaces of a car themselves, a roof, and the position and the shape of the antenna feeding part.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a view explaining a lattice structure rear glass antenna proposed according to an embodiment of the present invention;

FIG. 2 is a view explaining a car model on which a lattice structure rear glass antenna proposed according to an embodiment of the present invention is mounted;

FIGS. 3A and 3B are views showing an optimized lattice structure rear glass antenna structure according to an embodiment of the present invention;

FIGS. 4A and 4B are graphs that show the reflection loss of the lattice structure rear glass antenna illustrated in FIG. 3;

FIGS. 5A and 5B are graphs that show the vertical polarization radiation gain in a front-surface direction (q=90° and f=0°) of the lattice structure rear glass antenna illustrated in FIG. 3; and

FIGS. 6A to 6D are graphs that show the vertical polarization radiation gain of the lattice structure rear glass antenna illustrated in FIG. 3.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

As described herein, the present invention features a car rear glass antenna comprising a plurality of horizontal lines and lattice lines formed in a vertical direction to the horizontal lines, wherein a conductive strip line is printed on a portion of the lattices to make current flow through the portion of the lattices.

In one embodiment, the plurality of horizontal lines are 12 to 18 horizontal lines, and 5 to 6 of the horizontal lines from an upper end thereof correspond to an AM antenna, while the others thereof correspond to an FM antenna.

In another embodiment, the conductive strip line is printed only on the lattices that correspond ⅔ of the plurality of horizontal lines from a lower end thereof only for the FM antenna.

In another further embodiment, the conductive strip line is printed on the lattices that correspond to all of the horizontal lines for the FM antenna and the AM antenna.

In still another embodiment, the position of the lattices is changed in accordance with the position of the conductive strip line to be suitable to an FM diversity antenna or a TDMB antenna.

In another further embodiment, a gap between the lattice lines is more than twice the gap between the horizontal lines.

In one embodiment, the number of the lattice lines is substantially the same as the number of the horizontal lines.

In a further embodiment, the lattice lines are in the form of a trapezoid of which a lower portion is wider than an upper portion thereof, and the lattice lines are symmetrically positioned from their center.

In still another further embodiment, the car rear glass antenna further comprises antenna feeding parts provided on both side surfaces of the trapezoid.

In another further embodiment, the position of the lattice lines is determined by an impedance value that is changed in accordance with left and right side surfaces of a car themselves, a roof, and the position and the shape of the antenna feeding part.

Hereinafter, preferred embodiments of the present invention will be described in greater detail with reference to the accompanying drawings. The matters defined in the description such as a detailed construction and elements are nothing but the ones provided to assist in a comprehensive understanding of the invention. Thus, it is apparent that the present invention can be carried out without those defined matters.

According to preferred embodiments of the present invention, in order to suitably improve a vertical polarization radiation gain for the performance improvement of the vertical polarization radiation gain of the rear glass antennal and to extend an antenna bandwidth, a plurality of vertical lattice lines are suitably placed between horizontal heat lines at predetermined intervals from the center of the horizontal heat lines to form virtual lattices in order to widen the range of variables with respect to the number, position, and length of the vertical lines, and a conductive strip line is printed on each lattice to make current flow or not through the lattices. According to certain preferred embodiments, in this case, in order to secure a driver's visual field, the virtual lattices are set only on the vertical lines, and the number of virtual lattices is set to be equal or similar to the number of horizontal heat lines.

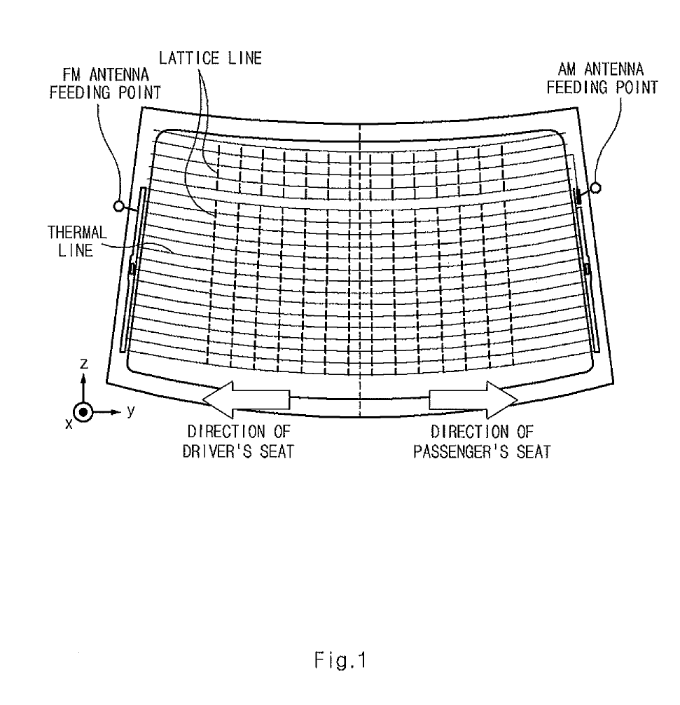

A car rear glass antenna according to certain exemplary embodiments of the present invention will be described with reference to FIGS. 1 to 6A to 6D. In particular, according to preferred exemplary embodiments of the present invention, the virtual lattice lines for improving the vertical polarization radiation gain and the matching bandwidth of the glass antenna are suitably converted into binary bits to determine design variables, and a commercial sedan car model is preferably used in a design process so that it has an optimum performance when it is applied to an actual car. According to certain preferred embodiments, in order to prove the utility of the lattice structure, a model in which only an FM antenna is suitably optimized and a mode in which AM and FM antennas are suitably optimized using the lattice structures have been proposed in the same car model, and respective antenna performances have been confirmed.

According to certain preferred embodiments and as shown in FIG. 1, FIG. 1 is a view explaining a lattice structure rear glass antenna.

As illustrated, according to certain exemplary embodiments of the present invention, rear glass is in the form of a trapezoid of which the length of the upper side is about 120 cm, and of which the length of the bottom side is about 130 cm. In further exemplary embodiments, 12 to 18 horizontal heat lines are printed at intervals of 1.5 to 3 cm, starting from a position that is about 10 to 15 cm distant from the bottom side. In another further embodiment of the present invention, the trapezoid has the upper side of 120 cm and the bottom side of 133 cm, and 16 horizontal heat lines are printed at intervals of 3 cm. Preferably, the rear glass also has a structure in which feeding is suitably performed on left and right sides of the rear glass. Virtual lattice lines are set at intervals of 6 cm, and are symmetrically positioned from the center thereof in consideration of the car fine view design.

According to further preferred embodiments, the operating frequency based on the design variable of the lattice structure is set to an FM radio frequency band (80 to 110 MHz), and the target of antenna performance is to make the impedance matching with an additional circuit advantageous by suitably improving the half-power bandwidth, and to satisfy the basic required conditions of the car antenna by obtaining the non-directional vertical polarization radiation pattern. According to other further preferred embodiments, two evaluation functions used for the target of antenna performance are given in the following equation (1).

$$First cost evaluation function = 1 - \frac{{BW}_{ANT}}{{BW}_{FM}} \\ Second cost evaluation function = \frac{1}{MN} {\sum }_{i = 1}^{M} {\sum }_{j = 1}^{N} \{ Gain ( {f}_{i} , θ = {0}^{∘} , {φ}_{j} ) \} \qquad ( 1 )$$

Here, 0°≦φⱼ≦360°, 80 MHz≦fᵢ≦110 MHz.

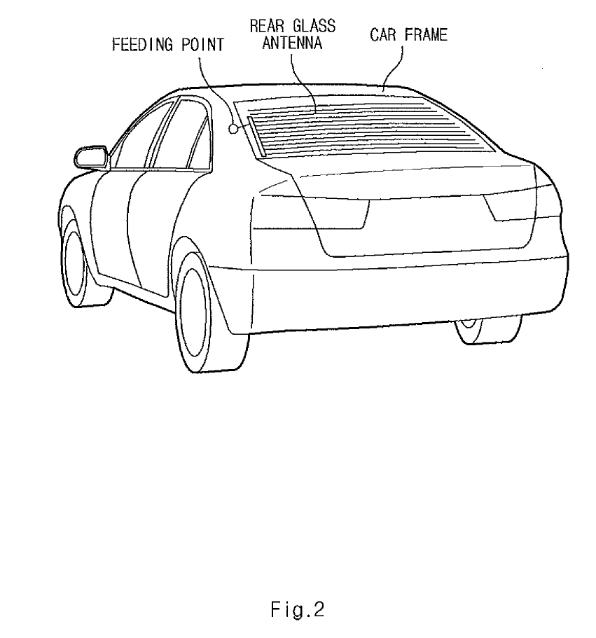

According to other further preferred embodiments and as shown in FIG. 2, FIG. 2 is a view explaining a car model on which a lattice structure rear glass antenna that is proposed according to an embodiment of the present invention is mounted. According to particular preferred embodiments, FIG. 2 shows a mesh shape to be used during analysis of the antenna performance as a car simulation model to be used for the design of a sedan rear glass antenna using vertical lines according to an embodiment of the present invention.

According to certain preferred embodiments, in measuring the antenna performance, since even in antennas having the same shape, the antenna impedance and the radiation pattern are suitably changed according to the mount position of the antenna in a car, and the antenna input impedance is suitably changed according to the position of feeding parts, it is very difficult to predict an accurate performance of the antenna. Accordingly, if the car body is modeled with a dense mesh structure and this model is used for the antenna analysis, the accuracy in performance prediction is suitably improved, but the optimization time is greatly increased due to the lengthened analysis time. Accordingly, a structure (left and right side surface of the car body, a roof, and the neighborhood of a feeding part) that is adjacent to the rear surface glass in which a lot of current is induced is analyzed with densely divided car meshes (about 100/1 is to 20/1), and portions, such as a wheel, the inside of an engine room, and the like, which exert a less influence upon the impedance and the radiation pattern of the antenna, are preferably removed to shorten the analysis time.

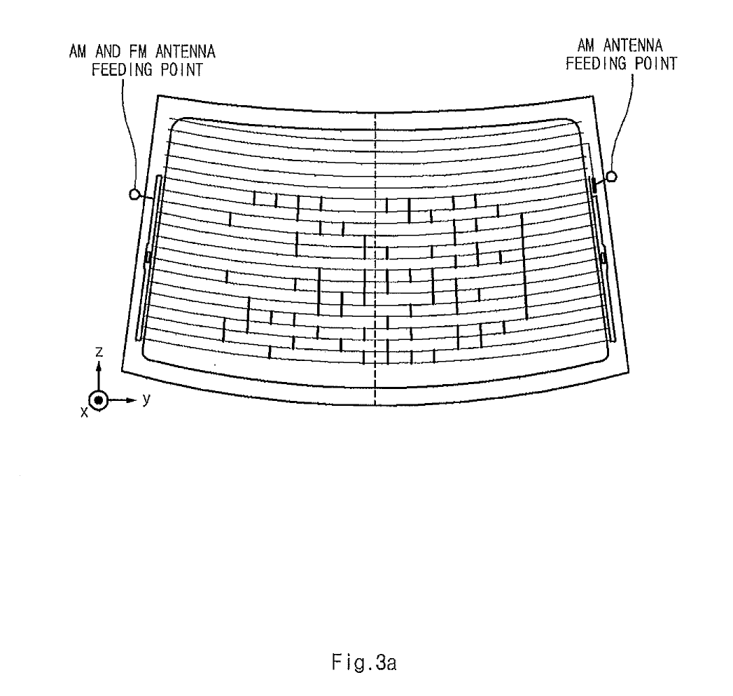

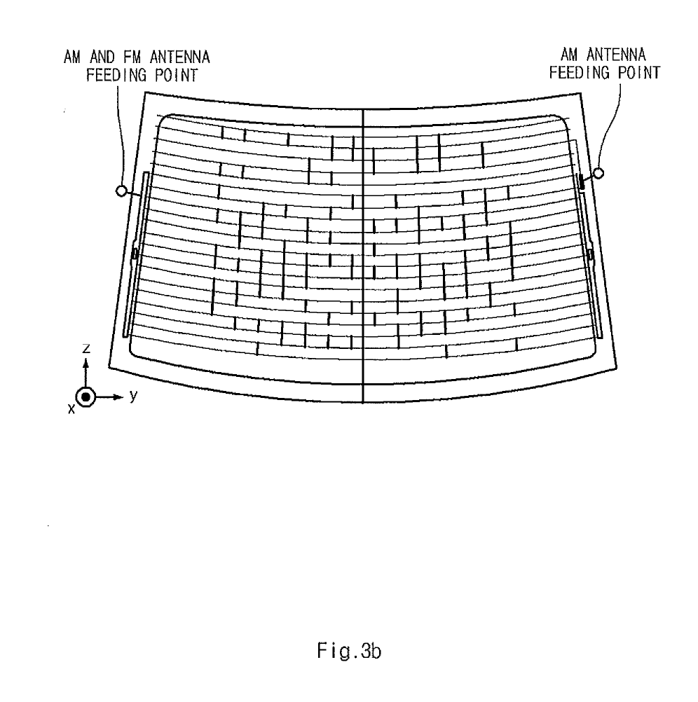

According to other preferred embodiments of the present invention and as shown in FIG. 3, FIGS. 3A and 3B are views explaining an optimized lattice structure rear glass antenna structure according to another preferred embodiment of the present invention. According to further preferred embodiments, FIG. 3A shows a first antenna in which only an FM antenna is suitably optimized as a lattice structure, and FIG. 3B shows a second antenna in which AM and FM antennas are suitably optimized as a lattice structure.

In general, a typical rear glass in the related art includes an FM antenna that is suitably designed for 15 horizontal heat lines from the lower end portion of the glass (a rear hood of the car) and an AM antenna (diversity specification, AM and FM antennas) that is suitably designed for 5 to 6 horizontal lines of the upper end portion. According to certain preferred embodiments, and referring to FIGS. 3A and 3B for example, the rear glass antenna according to an embodiment of the present invention includes vertical lines which are printed in a vertical direction to the horizontal heat lines. Preferably, in the structure for the FM antenna only as illustrated in FIG. 3A, no vertical line is suitably formed between the 5 to 6 horizontal lines of the upper end portion, but in the structure for the AM and FM antennas as illustrated in FIG. 3B, vertical lines are suitably formed between all of the horizontal lines of the upper end portions and lower end portions.

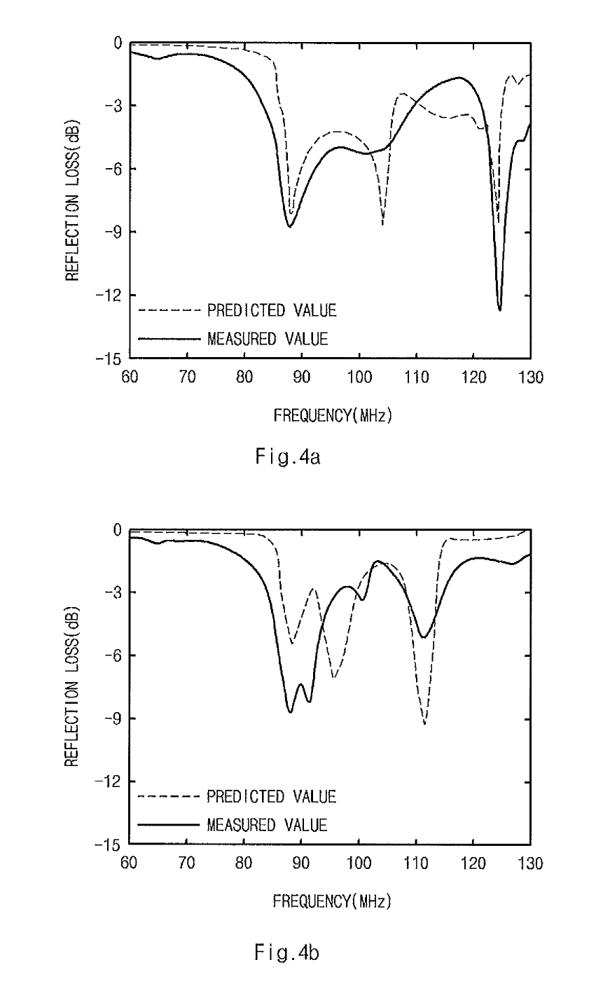

According to other preferred embodiments of the present invention and as shown in FIG. 4, FIGS. 4A and 4B are graphs explaining the reflection loss of the lattice structure rear glass antenna illustrated in FIG. 3. In further exemplary preferred embodiments, FIG. 4A shows simulation predicted values and measured values of the first antenna for the FM antenna only as illustrated in FIG. 3A, and FIG. 4B shows simulation predicted values and measured values for the second antenna for the AM and FM antennas as illustrated in FIG. 3B.

As illustrated, in certain preferred embodiments, it can be confirmed that the predicted values and the measured values of the first and second antennas are similar to each other, respectively. Also, in other further preferred embodiments, it can be confirmed that the first and second antennas have half-power bandwidths of 25% (S₁₁<−3 dB, 83 to 108 MHz) and 18% (S₁₁<−3 dB, 85 to 103 MHz), respectively, and wideband matching characteristics can be suitably obtained through multiple resonance.

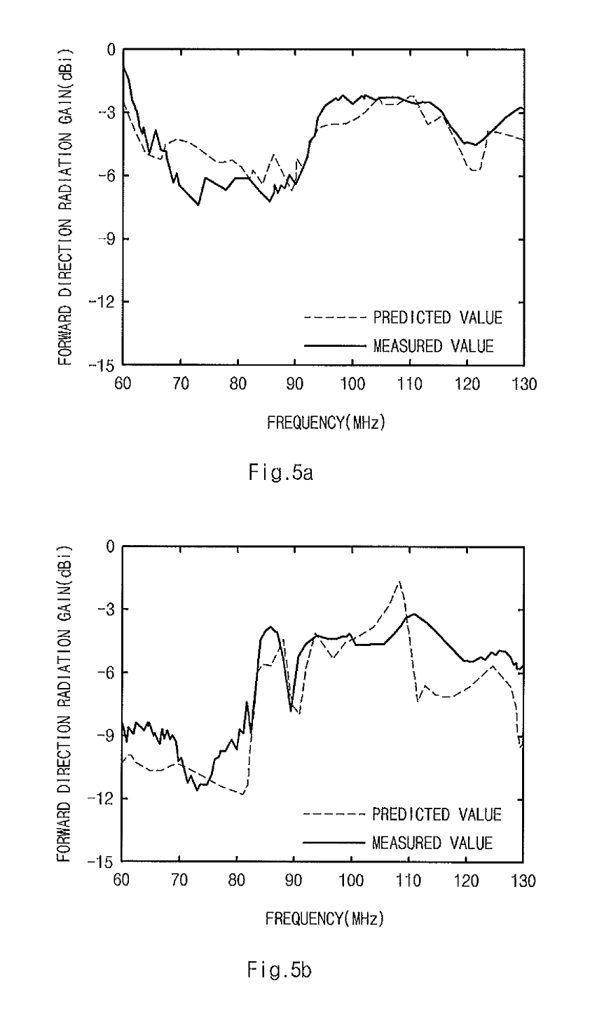

According to other preferred embodiments of the present invention and as shown in FIG. 3, FIGS. 5A and 5B are graphs illustrating the vertical polarization radiation gain in a front-surface direction (q=90° and f=°0) of the lattice structure rear glass antenna illustrated in FIG. 3. Specifically, FIG. 5A shows the vertical polarization radiation gain of the first antenna, and FIG. 5B shows the vertical polarization radiation gain of the second antenna.

As illustrated, according to certain preferred exemplary embodiments, the first antenna has the vertical polarization receiving performance of −13 dBi at minimum and −5.3 dBi on average at the frequency band of 80 to 110 MHz in which the FM radio channel exists as shown in FIG. 5A, and the second antenna has the vertical polarization receiving performance of −20 dBi at minimum and −7.76 dBi on average as shown in FIG. 5B.

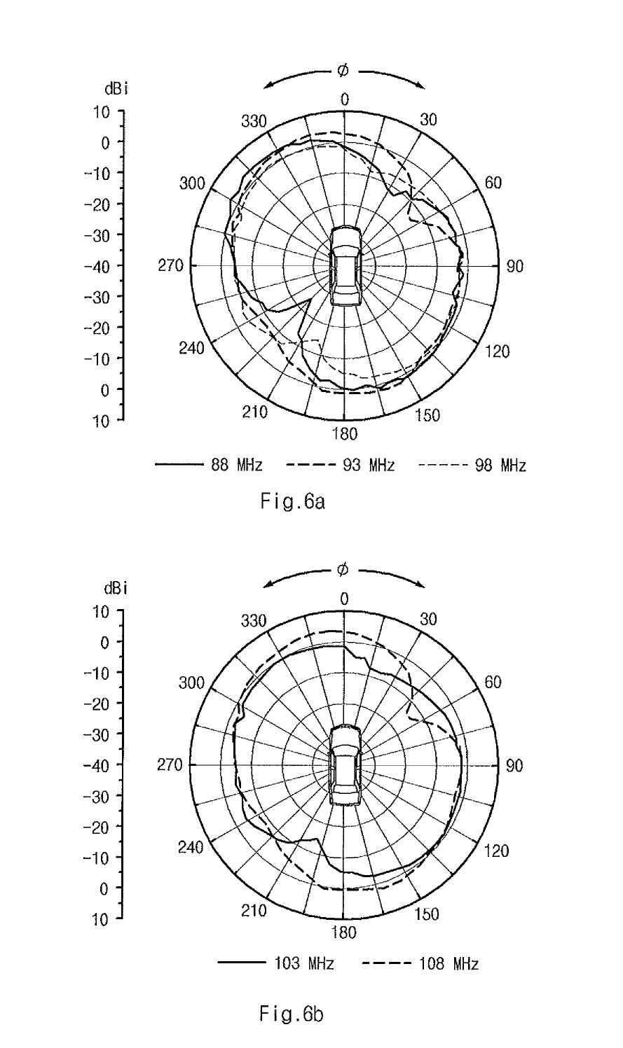

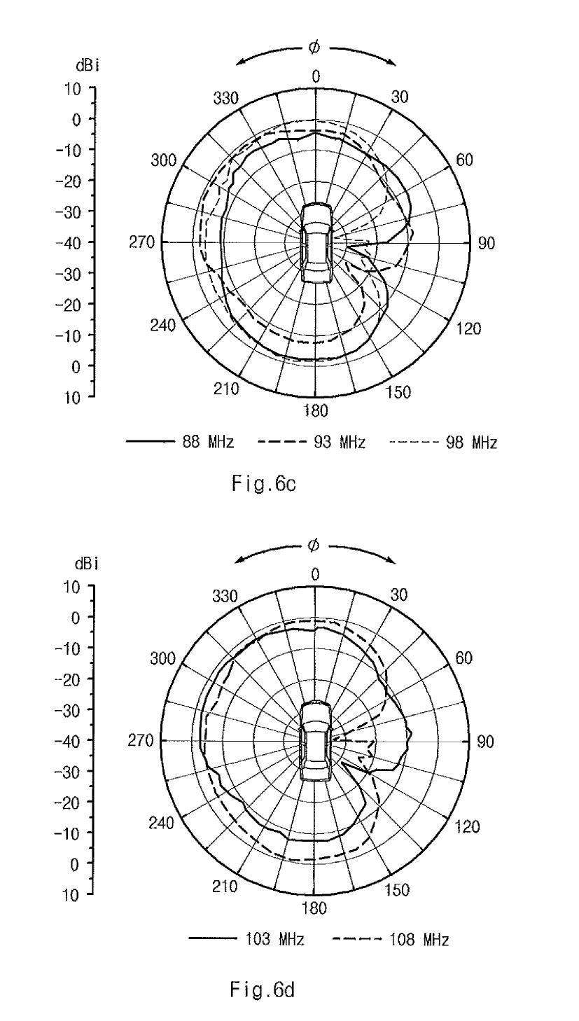

According to other preferred embodiments of the present invention and as shown in FIG. 6, FIGS. 6A to 6D are graphs illustrating the vertical polarization radiation gain of the lattice structure rear glass antenna illustrated in FIG. 3.

As illustrated, according to certain preferred embodiments, in order to verify the non-directional radiation pattern against the shadow effect by the car body itself, which is the required condition of the car antenna design, the radiation pattern in the vertical (azimuth) direction is suitably measured at the frequency band of 88, 93, 98, 103, and 108 MHz in which the FM radio channel exists. Preferably, the developed first and second antennas have average vertical polarization receiving performances of higher than −5 dBi and −8 dBi, respectively, in the vertical (azimuth) direction, and the shadow effect due to the car body does not greatly occurs in both the first and second antennas. Preferably, according to further preferred embodiments, the average vertical polarization receiving performance is suitably arranged in the following equation (2) as a value obtained by averaging the vertical polarization radiation gains measured at respective azimuth angles in 72 sections which are obtained by dividing 360° by 72 in the vertical (azimuth) direction at the measured frequency.

$${G}_{v . ave} ( dBi ) = \frac{1}{N} {\sum }_{j = 1}^{N} Gv ( {f}_{i} , θ = {90}^{∘} , {φ}_{j} ) \qquad ( 2 )$$

Here, fᵢ=88, 93, 98, 103, and 108 MHz.

As described herein, the rear glass antenna having a lattice structure according to preferred embodiments of the present invention can suitably improve the impedance matching due to the vertical lines inserted between the horizontal heat lines, and it can be confirmed through simulation that the vertical polarization radiation gain can be suitably improved by the plurality of vertical lines. Further, the lattice structure rear glass antenna can suitably improve the antenna performance without inserting an additional tuning line, and thus an efficient use of the rear glass becomes possible. Further, in the case of optimizing the antenna performance by applying the lattice structure to the rear glass antenna, the impedance matching can be suitably improved through the vertical lines inserted between the horizontal heat lines.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A car rear glass antenna comprising a plurality of horizontal lines and lattice lines formed in a vertical direction to the horizontal lines, wherein a conductive strip line is printed on a portion of the lattices to make current flow through the portion of the lattices.

2. The car rear glass antenna according to claim 1, wherein the plurality of horizontal lines are 12 to 18 horizontal lines, and 5 to 6 of the horizontal lines from an upper end thereof correspond to an AM antenna, while the others thereof correspond to an FM antenna.

3. The car rear glass antenna according to claim 1, wherein the conductive strip line is printed only on the lattices that correspond ⅔ of the plurality of horizontal lines from a lower end thereof only for the FM antenna.

4. The car rear glass antenna according to claim 1, wherein the conductive strip line is printed on the lattices that correspond to all of the horizontal lines for the FM antenna and the AM antenna.

5. The car rear glass antenna according to claim 1, wherein the position of the lattices is changed in accordance with the position of the conductive strip line to be suitable to an FM diversity antenna or a TDMB antenna.

6. The car rear glass antenna according to claim 1, wherein a gap between the lattice lines is more than twice the gap between the horizontal lines.

7. The car rear glass antenna according to claim 6, wherein the number of the lattice lines is substantially the same as the number of the horizontal lines.

8. The car rear glass antenna according to claim 1, wherein the lattice lines are in the form of a trapezoid of which a lower portion is wider than an upper portion thereof, and the lattice lines are symmetrically positioned from their center.

9. The car rear glass antenna according to claim 8, further comprising antenna feeding parts provided on both side surfaces of the trapezoid.

10. The car rear glass antenna according to claim 9, wherein the position of the lattice lines is determined by an impedance value that is changed in accordance with left and right side surfaces of a car themselves, a roof, and the position and the shape of the antenna feeding part.
